(19) United States
(12) Patent Application Publication
(10) Pub. No.: US 2010/0114970 A1
(43) Pub. Date: May 6, 2010

(54) DISTRIBUTED INDEX DATA STRUCTURE

(75) Inventor: Mauricio Marin, Santiago (CL)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/263,393

(22) Filed: Oct. 31, 2008

(51) Int. Cl. G06F 17/30

(52) U.S. Cl. 707/802; 707/E17.014; 707/E17.032

(57) ABSTRACT

The subject matter disclosed herein relates to forming a computer generated distributed index data structure.

### BACKGROUND

1. Field

The subject matter disclosed herein relates to data processing, and more particularly to methods and apparatuses that may be implemented to form a computer generated distributed index data structure through one or more computing platforms and/or other like devices.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided, which allow for the copious amounts of information to be searched through in an efficient manner. For example, service providers may allow for users to search the World Wide Web or other like networks using search engines. Similar tools or services may allow for one or more databases or other like data repositories to be searched. With so much information being available, there is a continuing need for methods and systems that allow for pertinent information to be analyzed in an efficient manner.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a procedure for indexing and/or ranking data objects in accordance with one or more exemplary embodiments.

FIG. 2 is a flow diagram illustrating a process for forming a computer generated distributed index data structure in accordance with one or more exemplary embodiments.

FIG. 3 is a diagram illustrating a series of blocks of a table of a distributed index data structure in accordance with one or more exemplary embodiments.

FIG. 4 is a diagram illustrating a series of blocks of a table of a distributed index data structure in accordance with one or more exemplary embodiments.

FIG. 5 is a diagram illustrating vertical and horizontal processing in a distributed index data structure in accordance with one or more embodiments in accordance with one or more exemplary embodiments.

FIG. 6 is a flow diagram illustrating a process for processing queries in a parallel computing environment in accordance with one or more exemplary embodiments.

FIG. 7 is a block diagram illustrating an embodiment of a computing environment system in accordance with one or more exemplary embodiments.

FIG. 8 is a diagram illustrates a metric space composed of a plurality of data objects in accordance with one or more exemplary embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Search engines may typically perform searches based on plain text queries. However, new applications may utilize data more complex than plain text. In such cases, search engines may be designed to include facilities to handle metric space databases. For example, metric spaces may be useful to model complex data objects such as images or audio. In such cases, queries may be represented by an object of the same type to those data objects modeled in a metric space database.

As used herein, the term “complex data object” may include, but is not limited to, any information in a digital format, of which at least a portion may be perceived in some manner (e.g., visually, audibly) by a user if reproduced by a digital device, such as, for example, a computing platform. For one or more embodiments, a complex data object may comprise a graphical object, such as, for example, digital image data. Additionally or alternatively, for one or more embodiments, such a complex data object may comprise an audio object, such as, for example, digital audio data. Also, for one or more embodiments, the complex data object may be associated with a number of elements. The elements in one or more embodiments may comprise text, for example, as may be displayed as part of a web page presentation. However, the scope of claimed subject matter is not limited in this respect. Each web page may contain embedded references to images, audio, video, other data objects, etc. One common type of reference used to identify and locate resources on the web is a Uniform Resource Locator (URL).

As will be discussed in greater detail below, a distributed index data structure may be generated and/or devised to support metric-space queries. Additionally, such a distributed index data structure may be generated and/or devised to support parallel query processing of such metric-space queries.

For example, such metric spaces may be composed of a universe of valid objects X associated with a distance function defined among such data objects. Such a distance function may be utilized to determine the similarity between two given data objects. In a search engine context a search of a given set of data objects may be performed based on a query. In such a case, both the given set of data objects and the query may be represented by the distance function with respect to such a metric space. Such a distance function may hold several properties, for example: strict positiveness (d(x, y)>0 and if d(x, y)=0 then x=y), symmetry (d(x, y)=d(y, x)), and the triangle inequality (d(x, z)<d(x, y)+d(y, z)). A finite subset of data objects may be represented within a metric space database.

Searches of such a metric space database may be based at least in part on several query types. For example, a range search may retrieve data objects within a given radius of a given query. Similarly, a nearest neighbor search may retrieve a most similar data object to a given query. Likewise, a k-nearest neighbors search may retrieve a set of similar data objects to a given query.

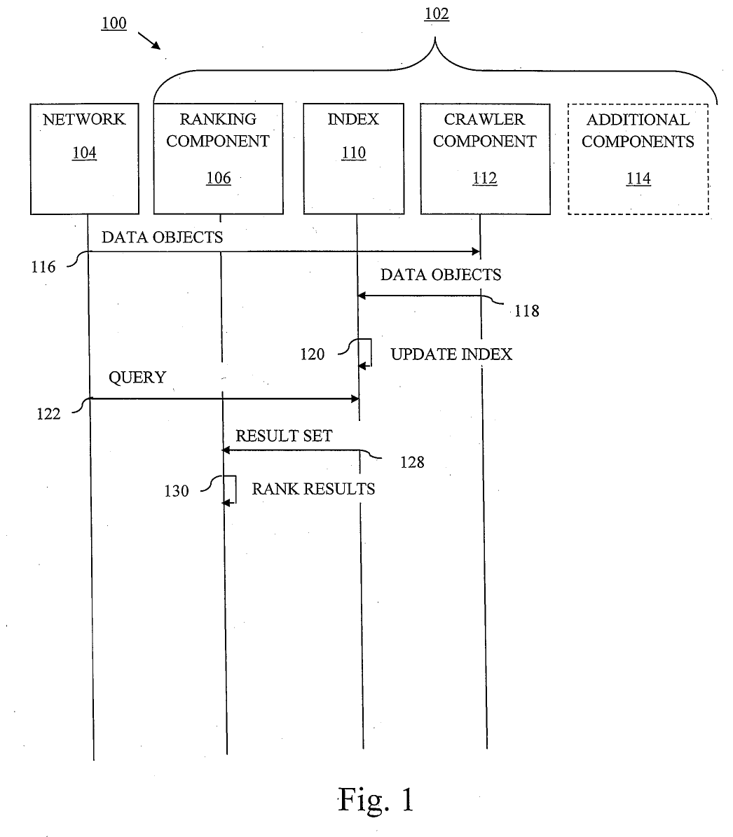

Procedure 100 illustrated in FIG. 1 may be used to index and/or rank data objects in accordance with one or more embodiments, for example, although the scope of claimed subject matter is not limited in this respect. Additionally, although procedure 100, as shown in FIG. 1, comprises one particular order of actions, the order in which the actions are presented does not necessarily limit claimed subject matter to any particular order. Likewise, intervening actions not shown in FIG. 1 and/or additional actions not shown in FIG. 1 may be employed and/or actions shown in FIG. 1 may be eliminated, without departing from the scope of claimed subject matter.

Procedure 100 depicted in FIG. 1 may in alternative embodiments be implemented in software, hardware, and/or firmware, and may comprise discrete operations. As illustrated, procedure 100 may be implemented to govern, at least in part, the operation of a search engine 102 and/or the like. Search engine 102 may be capable of searching for data objects of interest. Search engine 102 may be operatively enabled to communicate with a network 104 to access and/or search available information sources. By way of example, but not limitation, network 104 may include a local area network, a wide area network, the like, and/or combinations thereof, such as, for example, the Internet. Additionally or alternatively, search engine 102 and its constituent components may be deployed across network 104 in a distributed manner, whereby components may be duplicated and/or strategically placed throughout network 104 for increased performance.

Search engine 102 may include multiple components. For example, search engine 102 may include a ranking component 106, index 110, and/or a crawler component 112, as will be discussed in greater detail below. Additionally or alternatively, search engine 102 also may include various additional components 114. For example, search engine 102 may also include a search component capable of searching the data objects retrieved by crawler component 112. Search engine 102, as shown in FIG. 1, is described herein with non-limiting example components. Thus, as mentioned, further additional components 114 may be employed, without departing from the scope of claimed subject matter.

Crawler component 112 may retrieve data objects through network 104, as illustrated at action 116. For example, crawler component 112 may retrieve data objects and store a copy in a cache (not shown). Additionally, crawler component 112 may follow links between data objects so as to navigate across the Internet and gather information on an extensive number of data objects. For example, such data objects may comprise a set of data objects retrieved from network 104.

As will be described in greater detail below, data from data objects gathered by crawler component 112 may be sent to index 110, as illustrated at action 118. Index 110 may index such data objects, as illustrated at action 120. Index 110 may associate a given data object with a metric space based at least in part on distance function metrics, as discussed above. Additionally, identifying information of the data objects may also be indexed, so that identifying information as well as distance function metrics may be associated for a corresponding data object. Accordingly, search engine 102 may determine which data objects may relate to a query, as illustrated at action 122, based at least in part on a comparison of such a-query with indexed data objects. For example, such a query may also be associated with a metric space based at least in part on distance function metrics, so as to be comparable with such indexed data objects.

Ranking component 106 may receive a search result set from index 1 10, as illustrated at action 128. For example, search engine 102 may also include a search component (not shown) capable of searching the data objects indexed within index 110 so as to generate a result set. Ranking component 106 may be capable of ranking such a result set such that the most relevant data objects in the result set may be presented to a user first, according to descending relevance, as illustrated at action 130. For example, the first data object in the result set may be the most relevant in response to a query and the last data object in the result set may be the least relevant while still falling within the scope of the query. Such a ranked result set may comprise a search result that may be presented to a user.

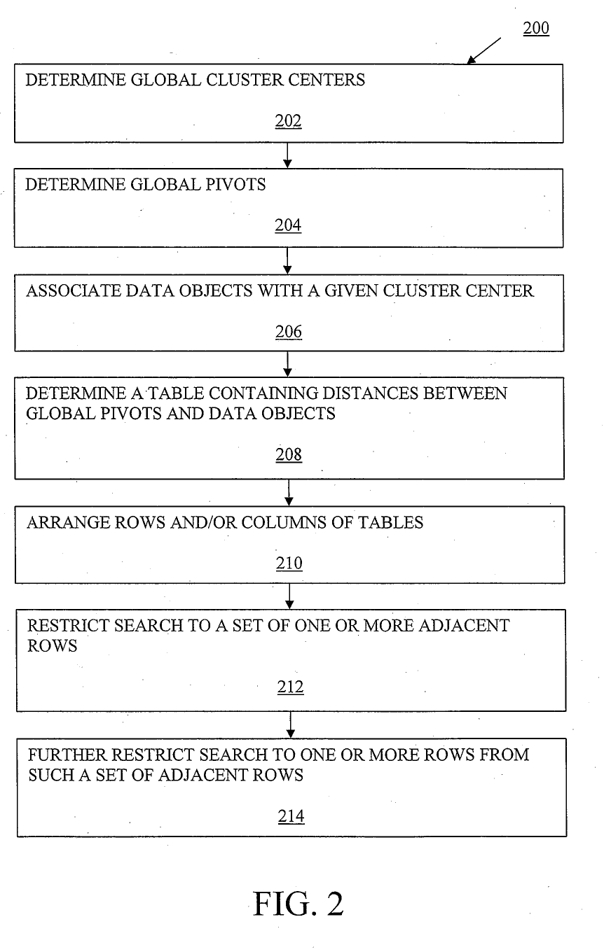

Referring to FIG. 2, a flow diagram illustrates a process for forming a computer generated distributed index data structure in accordance with one or more embodiments. Although process 200, as shown in FIG. 2, comprises one particular order of blocks, the order in which the blocks are presented does not necessarily limit claimed subject matter to any particular order. Likewise, intervening blocks shown in FIG. 2 and/or additional blocks not shown in FIG. 2 may be employed and/or blocks shown in FIG. 2 may be eliminated, without departing from the scope of claimed subject matter.

Process 200, depicted in FIG. 2, may in certain embodiments be implemented in software, hardware, and/or firmware, and may comprise discrete operations. As illustrated, process 200 may form a computer generated distributed index data structure. Such a distributed index data structure may be distributed among a set of two or more processors. As described in greater detail below such a distributed index data structure may be generated based on a combination between a cluster-type indexing strategy and a pivot-type indexing strategy. For example such a cluster-type indexing strategy may include List of Clusters (LC) and/or the like, and such a pivot-type indexing strategy may include Sparse Spatial Selection (SSS). In such a case, both global cluster centers (such as LC centers) and global pivots (such as SSS pivots) may be determined independently. Clusters of data objects may be formed based at least in part on such global cluster centers, and within each cluster a table may be determined based at least in part on such global pivots. Further details regarding cluster-type indexing strategy may be found in E. Chavez and G. Navarro, A Compact Space Decomposition for Effective Metric Indexing”, Pattern Recognition Letters, 26(9): pp. 1363-1376, 2005, although the scope of claimed subject matter is not limited in this respect. Further details regarding pivot-type indexing strategy may be found in N. R. Brisaboa and O. Pedreira, Spatial Selection of Sparse Pivots for Similarity Search in Metric Spaces, Proceedings of SOFSEM 2007, LNCS 4362, pp. 434-445, 2007 (Springer), although the scope of claimed subject matter is not limited in this respect.

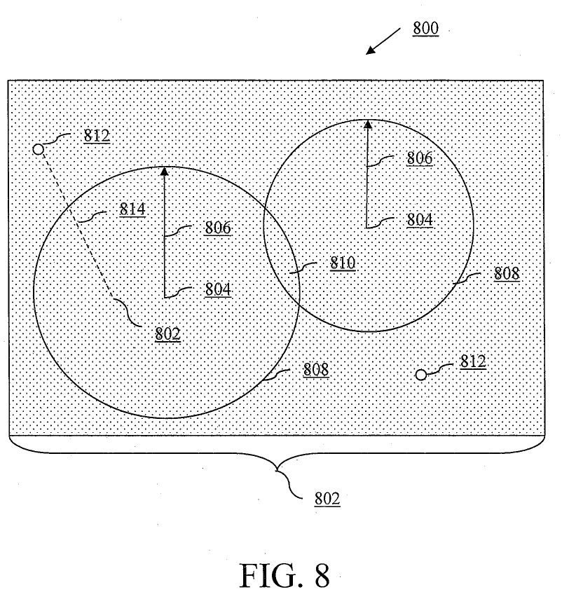

Referring to FIG. 8, a diagram illustrates a metric space composed of a plurality of data objects in accordance with one or more embodiments. As discussed above. Metric space 800 may be composed of a plurality of data objects 802 associated with a distance function defined among such data objects 802. Such a distance function may be utilized to determine the similarity between two given data objects 802. In a search engine context a search of a given set of data objects may be performed based on a query. In such a case, both the given set of data objects and the query may be represented by the distance function with respect to such a metric space 800.

Referring back to FIG. 2, starting at block 202, a two or more global cluster centers 804 (FIG. 8) may be determined. For example, such global cluster centers may be determined based at least in part on at least a portion of a set of data objects 802 (FIG. 8) distributed to two or more processors. As discussed above, such data objects may comprise complex data objects, such as digital image data, digital audio data, the like, and/or combinations thereof. As used herein the term “global” refers to items such as “cluster centers” that may be associated across all and/or a majority of a set of data objects distributed to two or more processors. For example, such global cluster centers may be shared among at least a portion of such a set of two or more processors. Conversely, as used herein the term “local” refers to items such as “local data objects” that may be associated across associated with a single given processor of such a set of two or more processors.

For example, such two or more global cluster centers 804 (FIG. 8) may be determined based at least in part on a cluster-type indexing strategy. One such cluster-type indexing strategy may include List of Clusters (LC). In such a case, an index may be built based at least in part on choosing a set of global cluster centers with associated radius 806 (FIG. 8), where data objects 802 (FIG. 8) may be associated with a given global cluster center 804 (FIG. 8) within the extension of a ball 808 (FIG. 8) of a given radius 806 (FIG. 8) extending from such a global cluster center 804 (FIG. 8). Such a ball 808 (FIG. 8) may contain the k data objects that may be the closet data objects to a respective given global cluster. Thus a radius 806 (FIG. 8) of such a ball 808 (FIG. 8) may be the maximum distance between such a global cluster center 804 (FIG. 8) and a k-nearest neighbor. Such balls 808 (FIG. 8) may be filled up as the global cluster centers 804 (FIG. 8) are created and thereby a given data object located in the intersection 810 (FIG. 8) of two or more of such balls 808 (FIG. 8) is assigned to a first global cluster center. Such a first global cluster center may be randomly chosen. Subsequent global cluster centers may be selected so that such global cluster centers may maximize the sum of the distances to previous global cluster centers.

In one example, such a determination of global cluster centers may be based at least in part on local data objects associated with an individual processor from a set of processors. Such local data objects may be a subset of a set of data objects, where that subset has been distributed to an individual processor. In such a case, candidate centers may be determined based at least in part on local data objects. For example, data objects may be uniformly distributed at random on such a set of processors. Individual processors may select candidate centers using its local data objects. Such candidate centers may be sent from an individual processor to other processors in the set of processors. Similarly, additional candidate centers from other processors in the set of processors may be received by such an individual processor. For example, lists of candidate centers may be broadcast between all processors in the set of processors. Two or more global cluster centers may then be selected from such candidate centers and/or from such additional candidate centers based at least in part on a sum of distances among such candidate centers and such additional candidate centers. For example, after receiving such lists of candidate centers, individual processors may refine these candidate centers, selecting global cluster centers based at least in part on computed distances among the local cluster centers that may maximize a sum of distance. From this point no communication may be required, and individual processors may build local portions of such a distributed index data structure using the shared global cluster centers to organize its local data objects into balls.

At block 204, two or more global pivots 812 (FIG. 8) may be determined. For example, such global pivots may be determined based at least in part on at least a portion of such a set of data objects distributed to two or more processors. As discussed above, “global” may refer to cluster centers and/or pivots that may be shared within a set of two or more processors, as compared with local data objects, which may be objects locally associated with a single given processor. For example, such global pivots may be shared among at least a portion of a set of two or more processors. Conversely, in a given cluster, local pivots could be calculated based on data objects located in such a cluster. However, quality of pivots may be lessened in cases where such pivots are restricted to a subset of the database (i.e. local pivots). For example, the total number of local pivots may tend to be unnecessarily large as compared to global pivots to achieve similar results in cases where the quality of pivots may be lessened due to their local nature.

For example, such two or more global pivots may be determined based at least in part on a pivot-type indexing strategy. One such pivot-type indexing strategy may include Sparse Spatial Selection (SSS). In such a case, an index may be built based at least in part on choosing a set of some data objects as pivots from a set of data objects. Efficiency may be impacted by the method employed to calculate global pivots. To be cost effective, global pivots may be selected which may reduce a total number of distance computations that may be made between a set of data objects and a given query. During determinations of a set of global pivots, a metric space may be identified as (X, d), U⊂X a set of data objects, and M a maximum distance between any pair of objects, as follows:

M=max {d(x, y)/x, y ∈ X} (1)

A set of global pivots may contain initially only a first data object from the set of data objects. Then, individual elements xᵢ ∈ U, xᵢmay be selected as a new global pivot if its distance to every global pivot in the current set of global pivots is equal or greater than αM, where α may be a constant parameter. Therefore, a data object in the set of data objects may be added to a set of global pivots if it is located at more than a fraction of a maximum distance with respect to current global pivots.

In one example, such a determination of global pivots may be based at least in part on local data objects associated with an individual processor from a set of processors. Such local data objects may be a subset of a set of data objects, where that subset has been distributed to an individual processor. In such a case, candidate pivots may be determined based at least in part on local data objects. For example, data objects may be uniformly distributed at random on such a set of processors. Individual processors may select candidate pivots using its local data objects. Such candidate pivots may be sent from an individual processor to other processors in the set of processors. Similarly, additional candidate pivots from other processors in the set of processors may be received by such an individual processor. For example, lists of candidate pivots may be broadcast between all processors in the set of processors. Two or more global pivots may then be selected from such candidate pivots and/or from such additional candidate pivots. For example, after receiving such lists of candidate pivots pⱼ, individual processors may refine these candidate pivots, selecting global pivots pᵢ that may satisfy the following condition:

d(pᵢ, pⱼ)≧αM, ∀≠j (2)

From this point no communication may be required, and individual processors may build local portions of such a distributed index data structure using the shared set of global pivots to build a local distance table associated with a given global cluster center.

At block 206, one or more data objects may be associated with a given cluster center. For example, such a given cluster center may be associated based at least in part on a closeness determination between such data objects and such global cluster centers. For instance, after a determination of global cluster centers at, block 202 and global pivots at block 204 based at least in part on a set of data objects distributed among a set of two or more processors, individual processors may attach data objects a closet global cluster center.

At block 208, determining a table (and/or other like data structure) containing distances 814 (FIG. 8) between one or more of such global pivots 812 (FIG. 8) and data objects 802 (FIG. 8) associated with a given global cluster center 804 (FIG. 8). For example, individual cells (and/or blocks) in such a table may contain a distance between a data object and a respective global pivot. Such distances may be used to solve queries as will be described in greater detail below. Further, within individual clusters, a table may be constructed which may contain distances of data objects in such a cluster to the global pivots. For example, such a table may be a local table that is based at least in part on local data objects associated with an individual processor. The number of global cluster centers and global pivots may be less than the total number of data objects in the set of data objects. In such a case, an index may be built based at least in part on choosing a set of some data objects as pivots from a set of data objects and then computing distances between such pivots and data objects from such a set. Such distance may be assembled into a table of distances where columns may be associated with such global pivots and rows may be associated with individual data objects. As used herein the term “table” may refer to an association between such global pivots and individual data objects, including, but not limited to a format for arranging and/or organizing data, such as for example, a table, a matrix, an array, and/or the like.

For example, a list of global cluster centers may be distributed on the set of processors, as discussed above at block 202. Such global cluster centers may be the same and/or similar in individual processors in the set of processors. For example, such global cluster centers may be the same and/or similar across each processor in the set of processors. A list of clusters may be built in individual processors in the set of processors. Individual data objects may be associated with individual global cluster centers based at least in part on a closeness determination between such data objects and such global cluster centers, as discussed above at block 206. A table of distances may associate distances between individual data objects associated with a given global cluster center and a set of global pivots, as discussed above at block 208. Such global pivots may be the same and/or similar in individual tables of distances associated with individual clusters. For example, such global pivots may be the same and/or similar across each processor in the set of processors.

At block 210, columns and/or rows of such a table may be arranged. In one example, a cumulative sum of distances between global pivots and data objects associated with individual columns. In such a case, two or more columns of such a table may be arranged based at least in part on such a cumulative sum of distances between global pivots and data objects. Such a table may include columns associated with respective global pivots and rows associated with respective data objects. However, it will be understood that while the use of the terms “row” and “column” may be utilized to distinguish between different axis of a given table, such a given row/column relationship may be inverted so that columns are arranged as rows and vice versa.

Similarly, two or more rows of a table may be arranged based at least in part on such distances between global pivots and data objects. For example, two or more rows of a table may be arranged based at least in part on such distances associated with an individual column having a lowest cumulative sum of such distances. For example, rows of a table may be arranged based at least in part on a first column of such a table. Such sorting may allow a quick determination of candidates for query answers. For example, such a determination may define a range of table rows of contiguous memory upon which to put to work multi-core threads to reduce the number of candidates along the remaining portions of the table. To increase selectivity, the remaining columns may be multiplexed with respect to the distance between them. In such a case, a small percentage of the columns may be to be kept in primary memory and the rest may be kept in secondary memory.

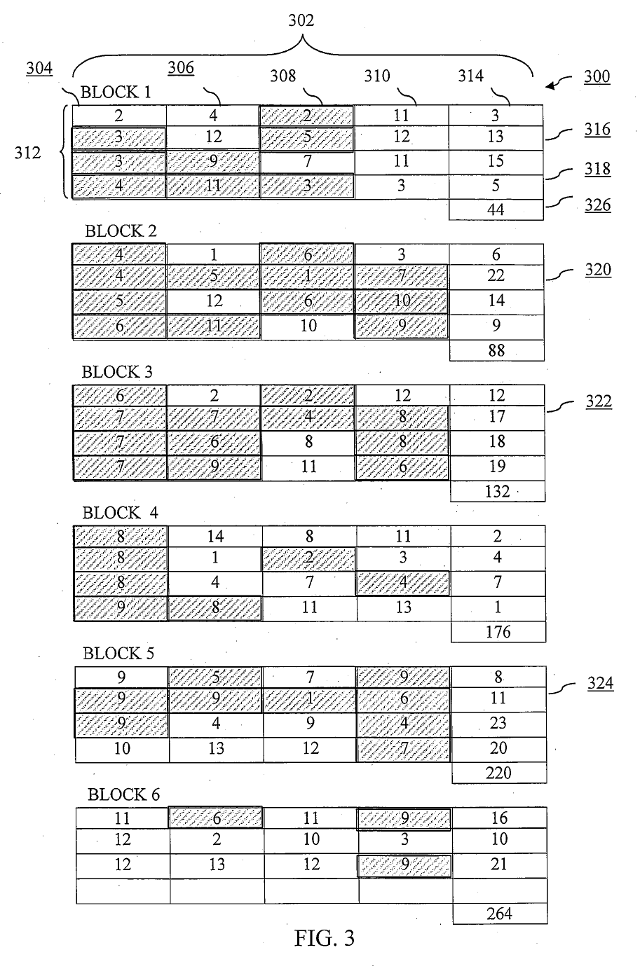

Referring to FIG. 3, a series of cells of a table illustrates a distributed index data structure in accordance with one or more embodiments. As shown, table 300 may include an arranged order of columns 302 associated with respective global pivots. For example, during construction and/or population of table 300, a cumulative sum may be calculated of the distances among all data objects and respective global pivots. Columns 302 associated with respective global pivots may be sorted by these cumulative sum values in increasing order so as to define a final order of global pivots. In a sorted sequence of pivots is p₁, p₂, . . . , pₙ, a first pivot 304 may be p₁, a second pivot 306 may be pₙ, a third pivot 308 may be p₂, a fourth pivot 310 may be pₙ₋₁ and so on. Likewise, as shown, table 300 may include an arranged order of rows 312 associated with respective local data objects. Such local data object may be associated with a given ID 314, which may be associated with a respective row 312. Such rows 312 in table 300 may be sorted by the values of first pivot 304 so that upon reception of a range query q with radius r a binary search may determine between which rows 312 may be located those data objects that can be selected as candidates to be part of an answer to a given query, as will be discussed below in greater detail.

Referring back to FIG. 2, at block 212, when a search query is received, a set of one or more adjacent rows in such a table may be determined with which to restrict a search for data objects. Such a determination may be based at least in part on a single column of a table. For example, columns in such a table may be associated with respective global pivots, while rows in such a table may be associated with respective data objects. Such a restriction of a search for data objects may be referred to herein as a “vertical processing” of one or more columns of a table. At block 214, such a search for data objects may be further restricted by determining one or more rows from such a set of one or more adjacent rows. As will be described in greater detail below, such further restriction may be based at least in part on vertical processing of one or more columns of a table, horizontal processing of one or more rows of a table, and/or a combination thereof. As will be discussed in greater detail below, such “horizontal processing” may utilize rows of such a table associated with respective data objects for a comparison of distances between such data objects and global pivots to distances between a query and global pivots. Accordingly, such “horizontal processing” may refer to a comparison working across a given row to restrict a search for data objects in cases where a distance in a given row of a table does not meet a certain condition. For a range query q with radius r, distances between the query and global pivots may be computed. Such distances between the query and global pivots may be compared against distances between data objects and global pivots in a table by applying a condition d(oᵢ, q)≦r. A data object oᵢ from the set of data objects can be discarded from the search in cases where there exists a global pivot pᵢ for which the condition |d(pᵢ, oᵢ)−d(pᵢ, q)|>r does not hold. Data object oᵢ that pass this test may be considered as potential members of the final set of data objects that form part of a solution for such a query.

With respect to such vertical processing, referring back to FIG. 3, such rows 312 in table 300 may be sorted (as described at block 210 of FIG. 2) by the values of first pivot 304 so that upon reception of a range query q with radius r a binary search may determine between which rows 312 may be located those data objects that can be selected as candidates to be part of an answer to a given query. Such an arrangement of rows 312 and/or columns 302 may have such an attribute because for those data objects oᵢ that may be part of an answer, such data objects oᵢ may be located between those rows 312 that satisfy the following binary bounds:

d(p₁, oᵢ)≧d(q, p₁)−r (3), and

d(p₁, oᵢ)≦d(q, p₁)+r (4)

Such vertical processing may be applied to a first column 304 and/or may be applied to subsequent columns 302. Further, such a re-organization of table columns 302 and/or rows 312 may, in certain implementations, increase operation speed. For example, such a gain in operation speed may comes from efficiency in effecting calculations for discarding data objects using the table as compared to computing distances between candidate data objects and a query.

With respect to such horizontal processing, distances between the query and global pivots may be compared against distances in a table between data objects and global pivots in rows by applying a condition d(oᵢ, q)≦r. Accordingly, a comparison working across a given row may further restrict a search for data objects in cases where a distance in a given row of a table does not meet such a condition. For example, a data object oᵢ from the set of data objects may be discarded from the search in cases where there exists a distance in a given row for which the condition |d(pᵢ, oᵢ)−d(pᵢ, q)|>r does not hold. Data object oᵢ that pass this test may be considered as potential members of the final set of data objects that form part of a solution for such a query.

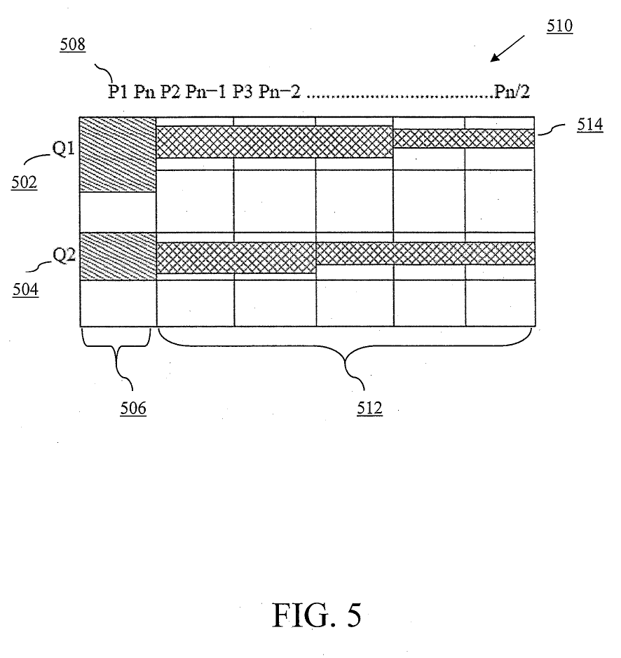

Referring to FIG. 5, a diagram illustrates vertical and horizontal processing in a distributed index data structure in accordance with one or more embodiments. In practice, during query processing two binary bounds may be placed on a first column of the table in an initial vertical processing to restrict a search for data objects. Subsequently, further restrictions to a search for data objects may take advantage of a column/row organization of a table of distances by performing vertical processing through applications of the triangular inequality (d(x, z)≦d(x, y)+d(y, z)) on the rows delimited by the results of the binary searches, followed by performing horizontal processing through applications of the triangular inequality to discard as soon as possible all data objects that are not potential members to be part of a query answer. FIG. 5 illustrates a first query 502 and second query 504 which may be processed concurrently. A vertical processing 506 may place two binary bounds on a first column 508 of table 510 in an initial vertical processing to restrict a search for data objects. Subsequent vertical processing (not shown) on one or more subsequent columns may also be utilized to further restrict a search for data objects. Additionally or alternatively, subsequent horizontal processing 512 of the rows delimited by such vertical processing 506 may also be utilized to further restrict a search for data objects. As a result, a set of data objects 514 corresponding to such a query 502 may be determined based at least in part on such vertical and/or horizontal processing.

For example, referring back to FIG. 3, the shaded cells may represent cases in which the triangular inequality gives a positive match for an example range query q with d(q, pᵢ)={6, 8,3, 7} for pivots pᵢ and radius r=3. As illustrated, a given query may be solved by performing one vertical process to a first column 304 to restrict a search for data objects to the shaded cells. This may be followed by a further restriction by a horizontal process for each row selected from first column 304. As the first column 304 may have been sorted by distance, it may only be necessary to perform two binary searches to detect a first row 316 with value d(q, p₁)−r=3 and a last row 318 with value d(q, p₁)+r=9. Then the sequence of horizontal processing of the triangular inequality may determines that the data object 22 (see row 320), data object 17 (see row 322), and data object 11 (see row 324) are candidates which may be directly compared against a query modeled as an object in a metric space database. Additionally or alternatively, a second vertical processing (not shown here) may have reduced the number of horizontal processes, which is a tradeoff that may depend on a given application.

For secondary memory, a combination of such strategies may increase the locality of accesses to memory and a processor may be able to keep in primary memory first columns 304 of more than one table. In certain example implementations, a number of first columns 304 set at a fraction of the set of columns of a table may be utilized to achieve competitive running times. In some applications, maintaining a fraction (such as a quarter of columns of a table, for example) may be sufficient to achieve performance suitable for certain operations. In such a case, remaining columns may be dropped without significant impact, for example.

Such a formation of a computer generated distributed index data structure based on both global cluster centers and global pivots may have at least two possible organizations for resultant tables of distances. For example, such organizations for tables of distances may be based at least in part on a set of cells stored in several contiguous portions of memory. In cases in which there is an existing collection of data objects, a sorting of first column 304 may be performed across several cells. In other cases, new data objects may be inserted in an on-line manner. In such an on-line insertion, cells may contain data objects as they were inserted with first columns 304 sorted locally. Such local sorting may be spread across two or more cells, where a number of cells to be sorted may be based at least in part on an amount of cells that may be held in primary memory.

One example physical organization of the index on contiguous portions of memory is illustrated in FIG. 3, which presents a first case for the distribution of a distance table with 23 data objects and 4 global pivots. Such a table may be partitioned in 5 cells (cells 1-5). The first 4 columns 304, 306, 308, and 310 may contain distances from data objects to 4 global pivots, and the last column 314 may contain respective data object IDs associated with each row 312. The cell 326 located at the bottom-right may indicate a physical address of a disk page containing a next table cell. Individual cells may be stored in contiguous disk pages. It may be assumed that a primary memory is large enough to store two cells of table 300. FIG. 3 may represent a case in which all data objects 1 . . . 23 may be available at construction time. In such a case, an external memory may be sorted by a first column 304.

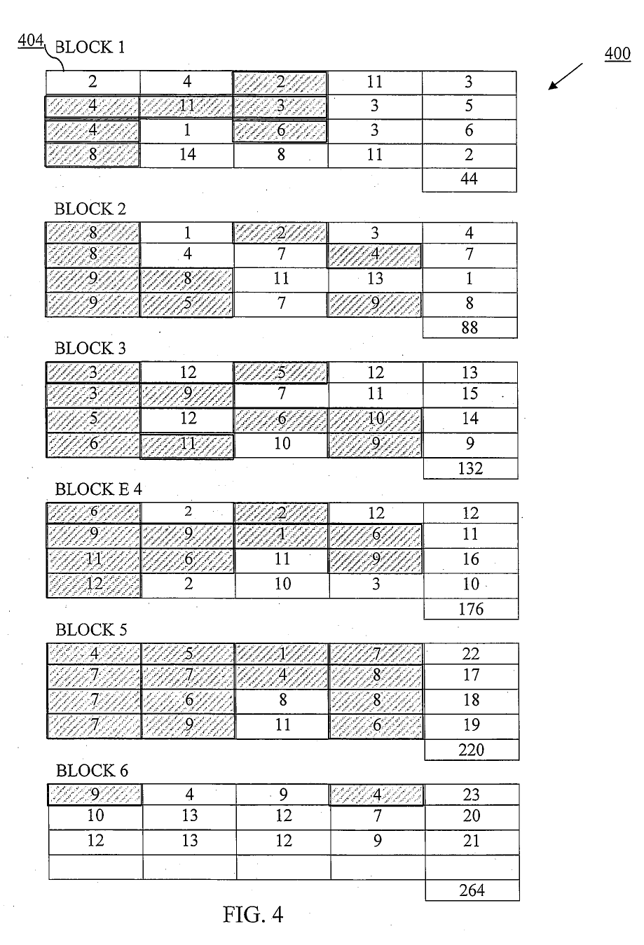

Another example physical organization of the index on disk pages is illustrated in FIG. 4, which presents a second case for the distribution of a distance table 400 with 23 data objects and 4 global pivots. FIG. 4 may represent a case in which data objects 1 . . . 23 may arrive one by one. For example, as data objects 1 . . . 23 arrive one by one to the index, in cases where a current cell is filled up a new cell may be started. In such a case, a first column 404 may be kept sorted every two cells, in cases where they both fit into primary memory. Thus, external sorting may not be required. Both strategies illustrated in FIGS. 3 and 4 may achieve a similar performance, which may indicate that formation of a computer generated distributed index data structure based on both global cluster centers and global pivots may efficiently support further updates once an index has been constructed from an initial set of data objects.

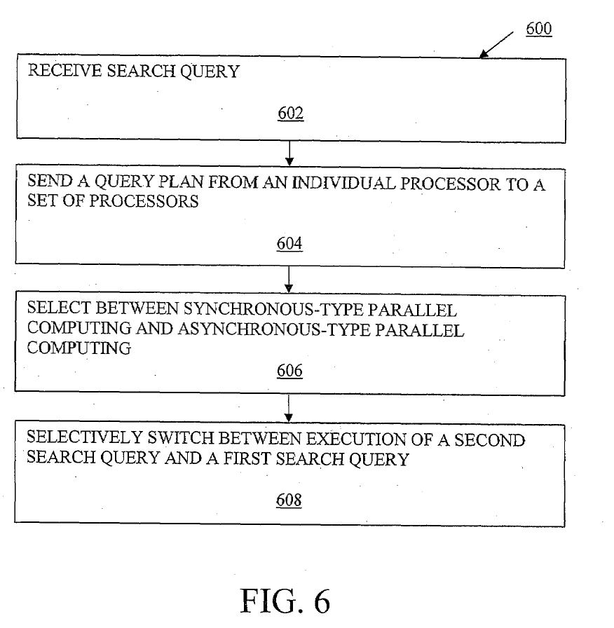

Referring to FIG. 6, a flow diagram illustrates a process for processing queries in a parallel computing environment in accordance with one or more embodiments. Although process 600, as shown in FIG. 6, comprises one particular order of blocks, the order in which the blocks are presented does not necessarily limit claimed subject matter to any particular order. Likewise, intervening blocks shown in FIG. 6 and/or additional blocks not shown in FIG. 6 may be employed and/or blocks shown in FIG. 6 may be eliminated, without departing from the scope of claimed subject matter.

Process 600, depicted in FIG. 6, may in certain embodiments be implemented in software, hardware, and/or firmware, and may comprise discrete operations. As illustrated, process 600 may illustrate parallel operations that may be utilized to form a computer generated distributed index data structure and/or to process queries considering a Synchronous/Asynchronous and/or a Round-Robin parallel query processing efficiency principle. For example, such parallel processing may be based on a set of processing nodes, where individual nodes may be composed of a set of multi-core CPUs and/or the like. In such a case, an index may be distributed on such a set of processing nodes and queries may be processed in individual nodes in parallel by using threads of such multi-core CPUs. Further, database objects may be uniformly distributed at random on the secondary memory of such nodes or such processors.

Starting at block 602, a search query may be received at an individual processor of a set of two or more processors. Such queries may be assumed to be received by a broker device and/or the like which in turn may route such queries to processors. For example, such a broker device may be in charge of sending queries to processors so that each query is sent to a single processor.

At block 604 a query plan may be sent from such an individual processor to at least a portion of such a set of processors. Such a query plan may indicate one or more clusters to be analyzed. Additionally, such a query plan may indicate distances between a search query and two or more global pivots. As discussed above, such clusters may include portions of a set of data objects associated with respective global cluster centers. For example, after receiving a query, a single processor in turn may be in charge of performing a ranking of local solutions to the query. Since global cluster-centers and global pivots are shared among the set of processors, an individual processor may calculate a query plan and send a query with its query plan to other processors in the set of processors. Such a query plan may indicate a global cluster center to be analyzed and the distances of the query to global pivots. As described above, such information may be then used to compute candidate data objects.

At block 606 such processing may select between synchronous-type parallel computing and asynchronous-type parallel computing based at least in part on a level of query traffic. In such a case, processing of such a query plan by at least a portion of such a set of processors may be based at least in part on synchronous-type parallel computing or asynchronous-type parallel computing. Such “synchronous-type parallel computing” may refer to a synchronous mode of operation such as bulk-synchronous model of parallel computing (BSP), for example. Further details regarding BSP may be found in L. G. Valiant, A bridging model for parallel computation, Comm. ACM, 33:pp. 103-111, August 1990, although the scope of claimed subject matter is not limited in this respect. In the case of BSP, a parallel computer may be seen as composed of a set of P processor local-memory components, which may communicate with each other through messages and/or the like. A computation may be organized as a sequence of “supersteps”. During a superstep, for example, individual processors may perform sequential computations on local data and/or send message to others processors from the set of processors. Such messages may be available for processing at their destination processor at a next superstep, and individual supersteps may be ended with a barrier synchronization of the set of processors. In one example, a realization of BSP may be built on top of a Message Passing Interface (MPI) communication library. For example, the procedures described herein may be implemented using the MPI standard and/or any other standard that allows performing message passing among computers forming a cluster, although the scope of claimed subject matter is not limited in this respect. Such “asynchronous-type parallel computing” may refer to an asynchronous mode of operation such a standard asynchronous message passing model of parallel computing implemented using a similar MPI communication library.

Switching between synchronous-type parallel computing and asynchronous-type parallel computing may be effected in accordance with observed query traffic. For example, in situations of decreased traffic it may be more efficient to operate in an asynchronous-type parallel computing mode. This may be true due at least to a barrier synchronization of processors performed in a synchronous-type parallel computing mode, under which such decreased traffic may become detrimental to performance in situations where load balance degrades significantly. Conversely, in situation where query traffic is increased, we have a synchronous-type parallel computing mode may profit from economy of scale by performing optimizations, such as bulk sending of messages among processors and proper load balancing of bulk query processing. For example, a broker device may measure traffic for use in deciding in which mode of operation the current queries can be processed. The arrival time of queries may be unpredictable and the departure time of queries may also be unpredictable over time. Thus, a broker device may estimate an average number of queries being processed during a fixed period of time. Such an estimate may be used to decide a mode of operation for the next period of time. For example, a broker device may determine what mode of operation may be more efficient based at least in part on an intensity of arrival rates of such queries. An average number of queries may be determined by modeling the system as a G/G/∞ queuing model, where service time is given by the response time to queries. Further details regarding a modeling of the system as a GIG/∞ queuing model may be found in M. Marin and V. Gil-Costa. (Sync|Async)⁺ MPI Search Engines. In 14th Euro PVM/MPI Recent Advances in Parallel Virtual Machine and Message Passing Interface, LNCS 4757, pages 117-124. Springer, Paris, France, Sep. 30-Oct. 3, 2007. Additional details regarding such Sync/Async and/or a Round-Robin parallel query processing may be found in U.S. patent application Ser. No. 12/058,385 filed Mar. 28, 2008.

At block 608, additionally or alternatively, such a query plan may be processed by at least a portion of such a set of processors. For example, such processing may selectively switch between processing of a second search query and such a search query. Such selective switching may be referred to herein as “Round-Robin” processing. Such an alternation may be based at least in part on a renewable number of computations and/or communications allocated to such a search query. Such Round-Robin processing may be achieved by assigning a similar amount of resources to individual queries being processed. In the context of BSP, in individual supersteps, individual queries may be granted a fixed number of distance calculations and/or a fixed number of computations on a distance table. Additionally or alternatively, this may also fix an amount of communication effected at the end of the superstep and a number of disk accesses. Thus a given query may require several supersteps to be completed.

For example, dealing efficiently with multiple user queries, each potentially at a different stage of processing at any given instant of time, may be at issue in large-scale search engines. Here, such use of Round-Robin processing may grant queries a similar share of the computational resources. Such a distribution of computational resources may, for example, reduce response time and/or may avoid unstable behavior caused by dynamic variations of query traffic. In addition, such use of Round-Robin processing may be suitable for new generations of multi-core processors in order to get the improved performance from new generations of hardware. Such Round-Robin processing may be applied by granting individual queries a fixed amount of use of resources such as calls to a distance function between data objects, calls to a triangular inequality that may be used to discard data objects from current candidate data objects, number of visited clusters, and/or a number of pivots compared against. Communication may also be granted in fixed quanta by sending portions of query plans to processing for individual queries until completing the processing of such a query plan in two or more iterations.

In operation, query processing may be effected by broadcasting each query to the set of processors and then individual processors may works on a partial solution of such a query. Here, for example, selected processor may be in charge of collecting the partial solutions to integrate them and return a set of results to a broker device. In this case, an individual processor may send its best R results. As there may be several queries being processed, an “integrator” processor for individual queries may be chosen (e.g., circularly) among the set of processors. As such, a degree of parallelism may be achieved during query processing.

As global cluster centers and/or global pivots may be the same at each processor, distance recalculations may be avoided among the queries and global cluster centers and/or global pivots. Further, the procedures described above may provide for increased efficiency performance as compared to other approaches, either in sequential operation and/or in parallel operation. Additionally, the procedures described above may provide for suitable treatment of secondary memory. Additionally, the procedures described above may support multi-core multi-threading, and/or the like.

In certain example implementations, a hybrid index based on global cluster centers and global pivots may be advantageous, for example, as its design may permit high locality in terms of data accesses performed by concurrent queries which may improve compatibility with secondary memory and/or multi-threading. In addition, Round-Robin processing of queries may improve query response times and avoid unstable behavior, etc., based at least in part on granting individual queries a share of hardware resources.

When operating in a bulk synchronous-type parallel computing mode parallelism of light multi-core threads may be exploited in a sort of naive parallelism. For example, individual threads may be used to process sequentially a subset of the queries being processed during a superstep. On the other hand, during an asynchronous-type parallel computing mode multi-core parallelism may be exploited in another way, by letting two or more “light” threads work cooperatively on single queries. In such a case, such light threads may work cooperatively on a subset of global pivots and/or global clusters centers as may be found more convenient at a particular instant.

The efficient performance and suitability for search engines and/or the like of the processes described above for forming a computer generated distributed index data structure and/or to processing queries may come from one or more aspects described above, such as: support for synchronous/asynchronous switching; support for a Round-Robin approach to query processing; support for efficient use of secondary memory where tables and/or the like are as described herein may be divided in large portions of contiguous memory; support for efficient use of light multi-threading as may be applicable in the context of multi-core processors; and/or use of global cluster centers (such as LC centers) and/or global pivots (such as SSS pivots) which may affect the number of calculations replicated at each processor, allow individual processors to formulate query plans, and/or support for electing good representatives of a set of data objects as global cluster centers and/or global pivots.

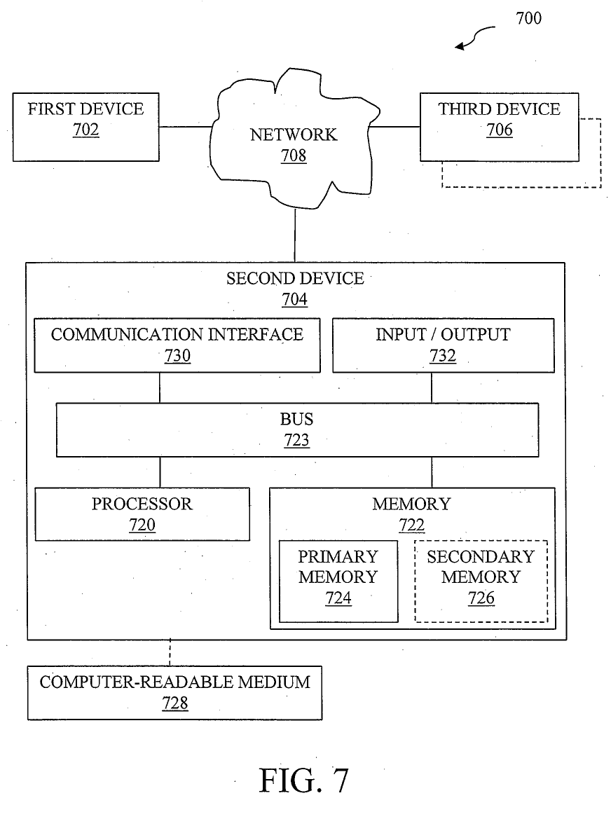

FIG. 7 is a block diagram illustrating an exemplary embodiment of a computing environment system 700 that may include one or more devices that may be operatively enabled to form a computer generated distributed index data structure and/or to process queries using one or more exemplary techniques illustrated above. For example, computing environment system 700 may be operatively enabled to perform all or a portion of process 100 of FIG. 1, process 200 of FIG. 2, and/or process 600 of FIG. 6.

Computing environment system 700 may include, for example, a first device 702, a second device 704 and a third device 706, which may be operatively coupled together through a network 708.

First device 702, second device 704 and third device 706, as shown in FIG. 7, are each representative of any device, appliance or machine that may be configurable to exchange data over network 708. By way of example, but not limitation, any of first device 702, second device 704, or third device 706 may include: one or more computing platforms or devices, such as, e.g., a desktop computer, a laptop computer, a workstation, a server device, storage units, or the like.

Network 708, as shown in FIG. 7, is representative of one or more communication links, processes, and/or resources configurable to support the exchange of data between at least two of first device 702, second device 704 and third device 706. By way of example, but not limitation, network 708 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated by the dashed lined box partially obscured behind third device 706, there may be additional like devices operatively coupled to network 708, for example.

It is recognized that all or part of the various devices and networks shown in system 700, and the processes and methods as further described herein, may be implemented using or otherwise include hardware, firmware, software, or any combination thereof.

Thus, by way of example, but not limitation, second device 704 may include at least one processor 720 that is operatively coupled to a memory 722 through a bus 723.

Processor 720 is representative of one or more circuits configurable to perform at least a portion of a data computing procedure or process. By way of example, but not limitation, processor 720 may include one or more processors, controllers, microprocessors, microcontrollers, application specific integrated circuits, digital signal processors, programmable logic devices, field programmable gate arrays, and the like, or any combination thereof.

Memory 722 is representative of any data storage mechanism. Memory 722 may include, for example, a primary memory 724 and/or a secondary memory 726. Primary memory 724 may include, for example, a random access memory, read only memory, etc. While illustrated in this example as being separate from processor 720, it should be understood that all or part of primary memory 724 may be provided within or otherwise co-located/coupled with processor 720.

Secondary memory 726 may include, for example, the same or similar type of memory as primary memory and/or one or more data storage devices or systems, such as, for example, a disk drive, an optical disc drive, a tape drive, a solid state memory drive, etc. In certain implementations, secondary memory 726 may be operatively receptive of, or otherwise configurable to couple to, a computer-readable medium 728. Computer-readable medium 728 may include, for example, any medium that can carry and/or make accessible data, code and/or instructions for one or more of the devices in system 700.

Second device 704 may include, for example, a communication interface 730 that provides for or otherwise supports the operative coupling of second device 704 to at least network 708. By way of example, but not limitation, communication interface 730 may include a network interface device or card, a modem, a router, a switch, a transceiver, and the like.

Second device 704 may include, for example, an input/output 732. Input/output 732 is representative of one or more devices or features that may be configurable to accept or otherwise introduce human and/or machine inputs, and/or one or more devices or features that may be configurable to deliver or otherwise provide for human and/or machine outputs. By way of example, but not limitation, input/output device 732 may include an operatively enabled display, speaker, keyboard, mouse, trackball, touch screen, data port, etc.

Some portions of the detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A method for use in forming a computer generated distributed index data structure, wherein said distributed index data structure is distributed among a set of two or more processors, the method comprising:
determining two or more global cluster centers based at least in part on at least a portion of a set of data objects distributed to two or more processors;
determining two or more global pivots based at least in part on at least a portion of said set of data objects distributed to two or more processors;
associating one or more data objects with a given cluster center of said two or more global cluster centers, wherein said given cluster center may be associated based at least in part on a closeness determination between said one or more data objects and said two or more global cluster centers; and
determining a table containing distances between one or more of said global pivots and said data objects associated with said given global cluster center.

2. The method of claim 1, wherein said two or more global cluster centers are shared among two or more processors of said set of processors, and wherein said two or more global pivots are shared among two or more processors of said set of processors.

3. The method of claim 1, wherein said determining two or more global pivots comprises:
determining one or more candidate centers based at least in part on local data objects associated with a given processor of said set of two or more processors, wherein said local data objects comprise a subset of said set of data objects distributed to said given processor;
sending said one or more candidate centers from said given processor to one or more of said set of two or more processors;
receiving one or more additional candidate centers from one or more of said set of two or more processors; and
selecting said two or more global cluster centers from said one or more candidate centers and/or from said one or more additional candidate centers based at least in part on a sum of distances among said one or more candidate centers and said one or more additional candidate centers.

4. The method of claim 1, wherein said determining two or more global pivots comprises:
determining one or more candidate pivots based at least in part on local data objects associated with a given processor of said set of two or more processors, wherein said local data objects comprise a subset of said set of data objects distributed to said given processor;
sending said one or more candidate pivots from said given processor to one or more of said set of two or more processors;
receiving one or more additional candidate pivots from one or more of said set of two or more processors;
selecting said two or more global pivots from said one or more candidate pivots and/or from said one or more additional candidate pivots.

5. The method of claim 1, wherein said table comprises a local table based at least in part on local data objects associated with a given processor, wherein said local data objects comprise a subset of said set of data objects distributed to said given processor.

6. The method of claim 1, further comprising:
arranging two or more columns of said table based at least in part on a cumulative sum of said distances between said global pivots and said data objects associated with individual columns, wherein columns in said table are associated with respective global pivots and rows in said table are associated with respective data objects; and
arranging two or more rows of said table based at least in part on said distances between said global pivots and said data objects associated with a given column of said two or more columns, and wherein said given column has the lowest cumulative sum of said distances among said two or more columns.

7. The method of claim 1, further comprising:
determining a set of one or more adjacent rows in said table with which to restrict a search for data objects corresponding to a search query, wherein said determination is based at least in part on a single column of said table, wherein columns in said table are associated with respective global pivots and rows in said table are associated with respective data objects; and
determining one or more rows from said one or more adjacent rows which to restrict said a search for data objects corresponding to a search query.

8. The method of claim 1, wherein said data objects comprise complex data objects.

9. The method of claim 1, further comprising:
receiving a search query at a given processor of said set of two or more processors;
sending a query plan from said given processor to at least a portion of said set of two or more processors, wherein said query plan indicates one or more clusters to be analyzed and distances between said search query to said two or more global pivots, wherein said clusters comprise portions of said set of data objects associated with respective global cluster centers; and
processing said query plan by at least a portion of said set of two or more processors.

10. The method of claim 1, further comprising:
receiving a search query at a given processor of said set of two or more processors;
sending a query plan from said given processor to at least a portion of said set of two or more processors;
processing said query plan by at least a portion of said set of two or more processors; and
selectively switching between processing a second search query and said search query based, at least in part, on a renewable number of computations and/or communications allocated to said search query.

11. The method of claim 1, further comprising:
receiving a search query at a given processor of said set of two or more processors;
sending a query plan from said given processor to at least a portion of said set of two or more processors;
selecting between synchronous-type parallel computing and asynchronous-type parallel computing based at least in part on a level of query traffic; and
processing said query plan by at least a portion of said set of two or more processors based at least in part on synchronous-type parallel computing or asynchronous-type parallel computing.

12. The method of claim 1, further comprising:
determining one or more candidate centers based at least in part on local data objects associated with a given processor of said set of two or more processors, wherein said local data objects comprise a subset of said set of data objects distributed to said given processor;
sending said one or more candidate centers from said given processor to one or more of said set of two or more processors;
receiving one or more additional candidate centers from one or more of said set of two or more processors;
selecting said two or more global cluster centers from said one or more candidate centers and/or from said one or more additional candidate centers based at least in part on a sum of distances among said one or more candidate centers and said one or more additional candidate centers;
determining one or more candidate pivots based at least in part on local data objects associated with a given processor of said set of two or more processors, wherein said local data objects comprise a subset of said set of data objects distributed to said given processor;
sending said one or more candidate pivots from said given processor to one or more of said set of two or more processors;
receiving one or more additional candidate pivots from one or more of said set of two or more processors;
selecting said two or more global pivots from said one or more candidate pivots and/or from said one or more additional candidate pivots;
wherein said two or more global cluster centers are shared among two or more processors of said set of processors, and wherein said two or more global pivots are shared among two or more processors of said set of processors;
wherein said table comprises a local table based at least in part on local data objects associated with a given processor, wherein said local data objects comprise a subset of said set of data objects distributed to said given processor; and
wherein said data objects comprise complex data objects.

13. An article comprising:
a computer-readable medium comprising computer-readable instructions stored thereon, which, if executed by one or more processors, operatively enable a computing platform to:
form a computer generated distributed index data structure, wherein said distributed index data structure is distributed among a set of two or more processors, comprising:
determine two or more global cluster centers based at least in part on at least a portion of a set of data objects distributed to two or more processors;
determine two or more global pivots based at least in part on at least a portion of said set of data objects distributed to two or more processors;
associate one or more data objects with a given cluster center of said two or more global cluster centers, wherein said given cluster center may be associated based at least in part on a closeness determination between said one or more data objects and said two or more global cluster centers; and
determine a table containing distances between one or more of said global pivots and said data objects associated with said given global cluster center.

14. The article of claim 13, wherein said computer-readable instructions, if executed by the one or more processors, operatively enable the computing platform to:
arrange two or more columns of said table based at least in part on a cumulative sum of said distances between said global pivots and said data objects associated with individual columns, wherein columns in said table are associated with respective global pivots and rows in said table are associated with respective data objects; and
arrange two or more rows of said table based at least in part on said distances between said global pivots and said data objects associated with a given column of said two or more columns, and wherein said given column has the lowest cumulative sum of said distances among said two or more columns.

15. The article of claim 13, wherein said computer-readable instructions, if executed by the one or more processors, operatively enable the computing platform to:
determine a set of one or more adjacent rows in said table with which to restrict a search for data objects corresponding to a search query, wherein said determination is based at least in part on a single column of said table, wherein columns in said table are associated with respective global pivots and rows in said table are associated with respective data objects; and
determine one or more rows from said one or more adjacent rows which to restrict said a search for data objects corresponding to a search query.

16. The article of claim 13, wherein said computer-readable instructions, if executed by the one or more processors, operatively enable the computing platform to:
receive a search query at a given processor of said set of two or more processors;
send a query plan from said given processor to at least a portion of said set of two or more processors;
select between synchronous-type parallel computing and asynchronous-type parallel computing based at least in part on a level of query traffic; and
process said query plan by at least a portion of said set of two or more processors based at least in part on synchronous-type parallel computing or asynchronous-type parallel computing.

17. An apparatus comprising:
a computing environment system, said computing environment system being operatively enabled to:
form a computer generated distributed index data structure, wherein said distributed index data structure is distributed among a set of two or more processors, comprising:
determine two or more global cluster centers based at least in part on at least a portion of a set of data objects distributed to two or, more processors;
determine two or more global pivots-based at least in part on at least a portion of said set of data objects distributed to two or more processors;
associate one or more data objects with a given cluster center of said two or more global cluster centers, wherein said given cluster center may be associated based at least in part on a closeness determination between said one or more data objects and said two or more global cluster centers; and
determine a table containing distances between one or more of said global pivots and said data objects associated with said given global cluster center.

18. The apparatus of claim 17, wherein said computing environment system is further operatively enabled to:
arrange two or more columns of said table based at least in part on a cumulative sum of said distances between said global pivots and said data objects associated with individual columns, wherein columns in said table are associated with respective global pivots and rows in said table are associated with respective data objects; and
arrange two or more rows of said table based at least in part on said distances between said global pivots and said data objects associated with a given column of said two or more columns, and wherein said given column has the lowest cumulative sum of said distances among said two or more columns.

19. The apparatus of claim 17, wherein said computing environment system is further operatively enabled to:
determine a set of one or more adjacent rows in said table with which to restrict a search for data objects corresponding to a search query, wherein said determination is based at least in part on a single column of said table, wherein columns in said table are associated with respective global pivots and rows in said table are associated with respective data objects; and
determine one or more rows from said one or more adjacent rows which to restrict said a search for data objects corresponding to a search query.

20. The apparatus of claim 17, wherein said computing environment system is further operatively enabled to:
receive a search query at a given processor of said set of two or more processors;
send a query plan from said given processor to at least a portion of said set of two or more processors;
select between synchronous-type parallel computing and asynchronous-type parallel computing based at least in part on a level of query traffic; and
process said query plan by at least a portion of said set of two or more processors based at least in part on synchronous-type parallel computing or asynchronous-type parallel computing.
